(19) United States
(12) Patent Application Publication
(10) Pub. No.: US 2021/0033906 A1
(43) Pub. Date: Feb. 4, 2021

(54) ADHESION STRUCTURE FOR A CURVED PROTECTION COVER

(71) Applicants: INTERFACE TECHNOLOGY (CHENGDU) CO., LTD., CHENGDU CITY (CN); INTERFACE OPTOELECTRONICS (SHENZHEN) CO., LTD., SHENZHEN CITY (CN); GENERAL INTERFACE SOLUTION LIMITED, MIAOLI COUNTY (TW)

(72) Inventor: JU YUN CHIANG, SHENZHEN CITY (CN)

(21) Appl. No.: 16/555,015

(22) Filed: Aug. 29, 2019

(30) Foreign Application Priority Data
Jul. 31, 2019 (CN) 201910700581.2

(51) Int. Cl. G02F 1/1339; G02F 1/1341

(52) U.S. Cl. CPC G02F 1/13394; G02F 2202/28; G02F 1/1341

(57) ABSTRACT

An adhesion structure for a curved protection cover comprises: a preformed film, an optical glue of flowing liquid material, and a curved protection cover. The preformed film is formed from a flexible film. The curved protection cover has a bottom surface and four side walls connecting to the bottom surface. A turning angle is configured between each side wall and the bottom surface. Each side wall includes a bonding area and a non-bonding, area. The preformed film is adhered to the bonding area via the optical glue. A groove is formed in such non-bonding area, so that the optical glue can be filled into the groove during the adhesion process so as to avoid the conventional overflowing phenomenon. In addition, the proposed groove can also be further used for the snap positioning of the process fixture or alternatively a positioning standard for a side curing light source.

This application claims priority for Chinese patent application no. 20191070058 L2 filed on Jul. 31, 2019, the content of which is incorporated by reference in its entirely.

### BACKGROUND OF THE INVENTION

### Field of the Invention

The present invention is related to an adhesion structure for a curved protection cover, and more particularly to an adhesion structure, in which a groove is formed in a non-bonding area of the curved protection cover so as to avoid the conventional optical glue being overflowing or wavy phenomenon.

### Description of the Prior Art

In accordance with the developments of touch panel devices and their screen display technologies, an exterior shape of the existing consumer 3C electronic products has been developing from a plane surface to a curved surface. In particular, as the flexible film has been widely used in the touch panel and display screen industries, the design of a curved surface apparently makes the fabricating process of the plane touch panel product much more complicated than before. And therefore, it is apparent that the existing technologies nowadays obviously cannot meet the new process requirements.

In general, the most common adhesion technology for curved surface in the, prior arts comprises the following two types. Please refer to FIG. 1 and FIG. 2 first, which show conventional schematic diagrams of directly bending a flexible film to perform adhesion process of the prior arts. in such a conventional methodology, it comprises: using a cover glass (CG) 1 to form a shape-designed rubber dig 2, and then employing the gap between the rubber jig 2 and an upper mold 3 to directly bend the flexible film 4 in shape and make it adhered to the cover glass 1, as shown in FIGS. 1 to 2.

Another adhesion technology for curved surface in the prior arts comprises using a pre-formed film, and then an optical adhesive is employed to make the pre-formed film adhered to a curved protection cover, as shown in FIGS. 3A to 3D. In specific, please refer to FIGS. 3A to 3B first. A flexible film 4a is pre-formed into a curved shape to fit with the protection cover to be adhered. After that, as shown in FIG. 3C, a Liquid Optically Clear Adhesive (LOCA) 5 is employed to adhere the pre-formed flexible film 4a to the curved protection cover la so as to form a final structure as shown in FIG. 3D.

However, it draws our attention that when a pre-formed flexible film is adhered to a curved protection cover through the liquid optically clear adhesive material, problems occur since a curved angle is inevitably configured in each of the four sides of the curved protection cover. Please refer to FIG. 4, as shown in the figure, since the adhesive liquid glue at a vertical wall 41 and a turning corner 43 of the curved protection cover cannot be precisely controlled during the adhesive process, the adhesive liquid glue being overflowing or wavy phenomenon will unavoidably occur at the vertical wall 41 or at the turning corner 43 of the curved protection cover so as to severely affect the process control of the overall structure as well as the production yield of the panel device itself.

Therefore, in view of considering the appearance design of the touch panel has developed into the field of curved surfaces and wide viewing angles, it is necessary to take various considerations regarding assembly evaluation of how to adhere the optical adhesive material in a curved protection cover structure. As a result, it should be apparent and obvious that there is indeed an urgent need for the professionals in the field for a novel and inventive adhesion structure for a curved protection cover to be developed that can effectively solve those above mentioned problems occurring in the prior design.

### SUMMARY OF THE INVENTION

In order to overcome the above mentioned disadvantages of the prior arts occurring in the adhesion process of a four-edge curved structure of the protection cover, in which a film is pre-formed by thermoforming and an optical adhesive is employed to adhere the film to the four-edge curved protection cover, it is absolutely important to effectively control the flow of the optical adhesive while the adhesion process is on-going. Meanwhile, the optical adhesive must be distributed uniformly at both the vertical wall and the turning corner of the four-edge curved protection cover, such that the conventional overflowing and wavy phenomenon of the optical adhesive can be successfully avoided. Based on these perspectives, one major objective in accordance with the present invention is provided for a novel and modified structure for a curved protection cover.

Another objective in accordance with the present invention is provided for an adhesion structure for the curved protection cover. When the modified structure of the curved protection cover is applied to be integrated in the adhesion process of the touch panel devices, the conventional overflowing and wavy phenomenon of its optical adhesive therein is proved to be under excellent control. As such. the process control efficiency of the whole adhesion structure and production yield of the touch panel devices are believed to be improved in a significant increase.

For achieving the above mentioned objectives, the present invention provides a modified structure of the curved protection cover, comprising a bottom surface and four sidewalls connecting to the bottom surface. A turning angle is configured to form between each sidewall and the bottom surface, and each sidewall comprises a bonding area and a non-bonding area, wherein a groove is formed in such non-bonding area.

As such, when a preformed film is adhered to the bonding area of the curved protection cover, the optical glue adhered in between is able to fill into such groove of the non-bonding area, so as to prevent the conventional overflowing and wavy phenomenon of the optical glue.

According to one embodiment of the present invention, the above mentioned curved protection cover is made of optical transparent materials. For instance, the curved protection cover can be made of crystal, glass, or resin.

According to one embodiment of the present invention, the grooves disposed on the four sidewalls of the curved protection cover are connecting with one another and form a circular type of groove on the sidewalls. To be more specific, the formed groove can be designed as a linear type of groove, a curve type of groove or other types having specific patterns. In addition, the formed groove can be, for example, fabricated by a wheel cutting or laser engraving method.

In another aspect, the present invention further provides an adhesion structure for the curved, protection cover, comprising at least: a preformed film, an optical glue and a curved protection cover, wherein the preformed film is selectively pre-formed from a flexible film.

The optical glue is made of flowing liquid material, and the curved protection cover comprises a bottom surface and four sidewalls connecting to the bottom surface. A turning angle is configured to form between each sidewall and the bottom surface, and each sidewall comprises a bonding area and a non-bonding area, The preformed film is adhered to the bonding area of the curved protection cover via the optical glue. Preferably, a groove is formed in such non-bonding area, such that the optical glue is able to fill into such groove of the non-bonding area when the preformed film is adhered to the bonding area of the curved protection cover, so as to prevent the optical glue from overflowing.

Furthermore, regarding planning the size of the groove to be designed, in a preferred embodiment of the present invention, the sidewall of the curved protection cover has a thickness, and a depth of the groove is less than one-third of the thickness of the sidewall.

Moreover, the non-bonding area in the sidewall of the curved protection cover has a non-adhesive height, and a height of the groove is less than half of the non-adhesive height.

In yet another aspect of the present invention, in order to apply the proposed structure much more widely into real applications, according to the adhesion structure for curved protection cover disclosed by the present invention, the circular type of groove can be further used for the snap positioning of its neighboring process fixture, such that the process fixture is able to be positioned in the circular type of groove. Alternatively, the circular type of groove can be further performing as a positioning standard for a side curing light source. As such, the light source disposed adjacent to one of the sidewalls of the curved protection cover can be effectively secured to the sidewall of the curved protection cover.

Therefore, by such novel designed arrangements of the present invention, the adhesion structure for a curved protection cover is well characterized by disposing the circular type of groove in the vertical walls of the four-edge curved protection cover which performs no touch control functions. As a result, when the preformed film is adhered to such the curved protection cover, the optical glue disposed there in between fills towards a horizontal direction after flowing into the designed groove. And by such, the conventional overflowing phenomenon of the optical glue can be prevented and controlled successfully.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 and FIG. 2 show conventional schematic diagrams of directly bending a flexible film to perform adhesion process of the prior arts.

FIG. 3A, FIG. 3B, FIG. 3C and FIG. 3D show conventional schematic diagrams of applying a preformed flexible film sequentially to perform adhesion process of the prior arts.

FIG. 4 shows a conventional schematic diagram of the traditional curved protection cover in which its adhesive liquid glue cannot be precisely controlled.

FIG. 5 shows a schematic structural view of a modified curved protection cover in accordance with a preferred embodiment of the present invention.

FIG. 6 shows a schematic structural view of the modified curved protection cover in practical application in accordance with FIG. 5 of the present invention.

FIG. 7A shows a schematic structural view of a linear type of groove in accordance with one embodiment of the present invention.

FIG. 7B shows a schematic structural view of a curve type of groove in accordance with another embodiment of the present invention.

FIG. 8A, FIG. 8B, and FIG. 8C show various schematic views representing the dimensions of the groove to he designed according to the preferred embodiment of the present invention.

FIG. 9A, FIG. 9B, and FIG. 9C show diagrams of the simulation results when the curved protection cover provided with a circular type of groove is applied to form its adhesion structure according to the preferred embodiment of the present invention.

FIG. 10A shows a schematic diagram of the modified curved protection cover when being brought into practical application in accordance with yet another embodiment of the present invention.

FIG. 10B shows another schematic diagram of the modified curved protection cover when being brought into practical application in accordance with yet another embodiment of the present invention.

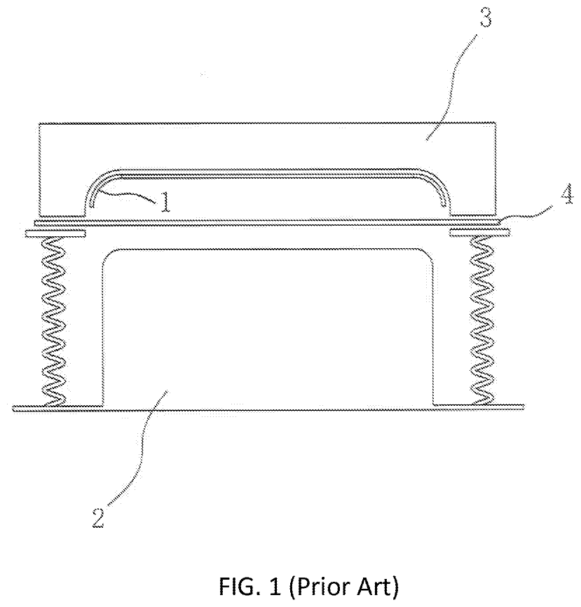

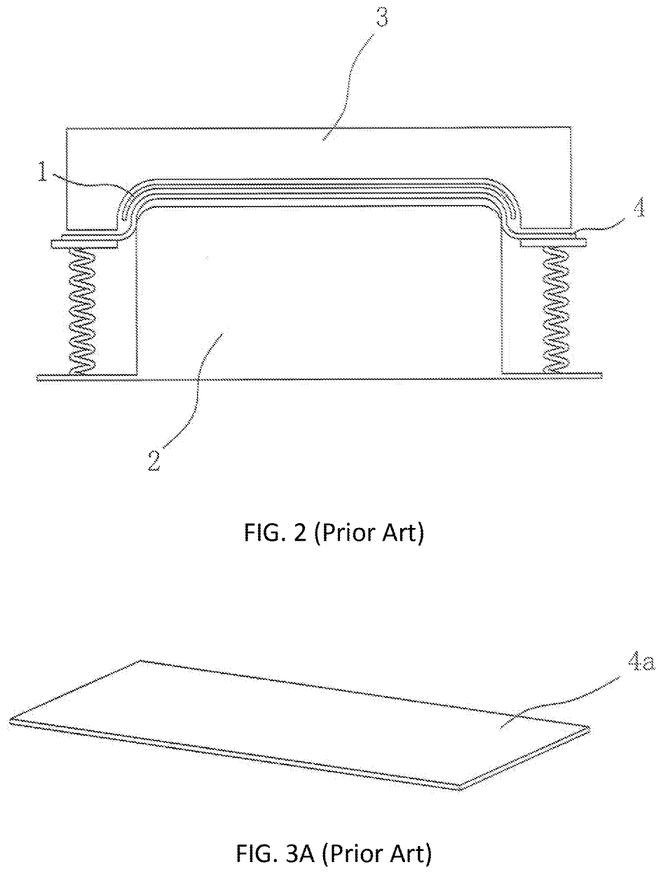

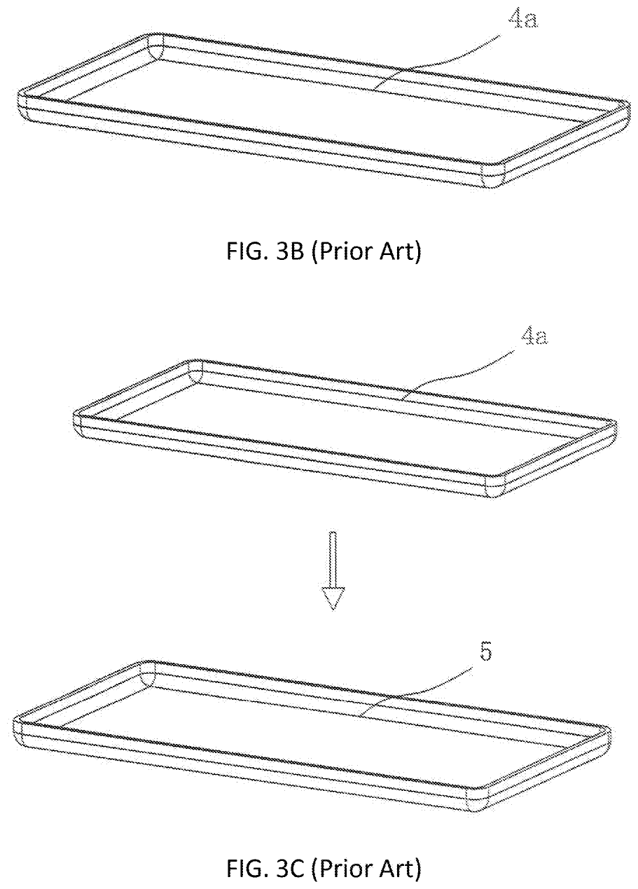

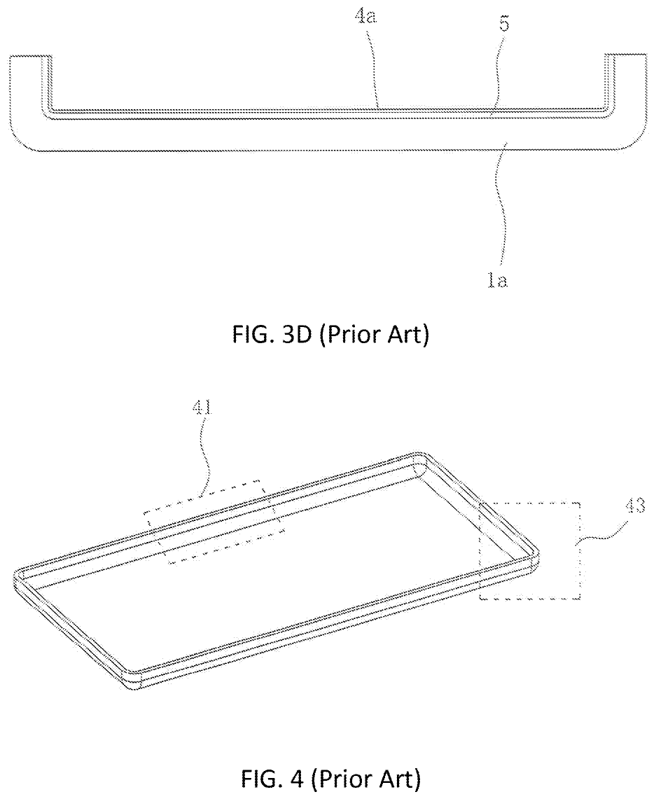

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The embodiments described below are illustrated to demonstrate the technical contents and characteristics of the present invention and to enable the persons skilled in the art to understand, make, and use the present invention. However, it shall be noticed that, it is not intended to limit the scope of the present invention. Therefore, any equivalent modification or variation according to the spirit of the present invention is to be also included within the scope of the present invention.

In order to solve the above mentioned problems occurring in the prior design that the adhesive liquid glue being overflowing or wavy phenomenon always occurs in the curved protection cover structure, the present invention is aimed to propose a novel solution, which is an adhesion structure for a curved protection cover. As described in the Description of the Prior Art, we have found, from the properties and trial results of the commonly used optical liquid glues, that when the optical liquid glue flows toward the boundary of a protection cover glass, it is tended to fill the gap in the horizontal direction first. And, after that, it overflows outwards the cover glass. This is mainly because the optical liquid glue itself has a very strong cohesive force. When the glue overflows to the edge of the protection cover, the cover edge performs as a blocking boundary for the optical glue.

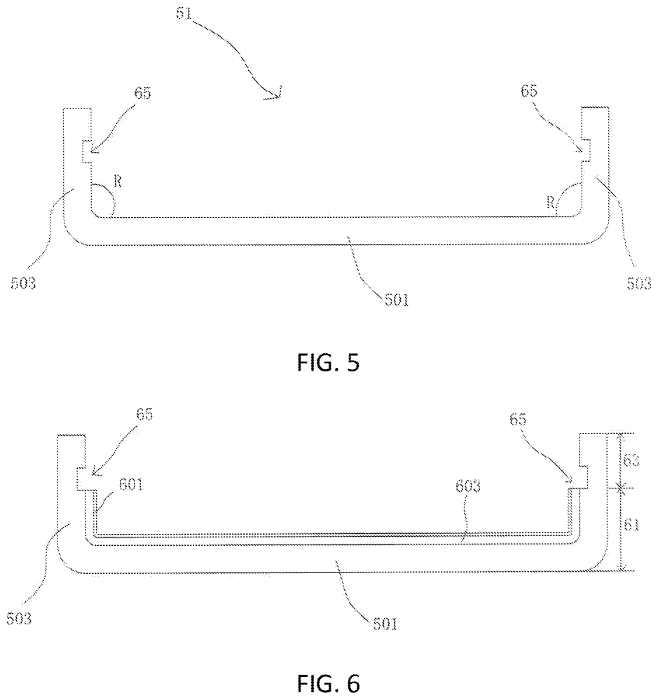

In view of this, please refer to FIG. 5, which shows a schematic structural view of a modified curved protection cover in accordance with a preferred embodiment of the present invention. By providing such specific embodiments of the present invention in conjunction with its corresponding figures, it is believed for those who are skilled in the art to have better understandings of the technical features of the present invention.

In details, the curved protection cover 51 comprises a bottom surface 501 and four sidewalls connecting to the bottom surface 501. The four sidewalls include a front sidewall, a back sidewall, a left sidewall and a right sidewall. Since FIG. 5 merely shows a side perspective view of the curved protection cover 51 from one side of the present invention, only the left sidewall and the right sidewall 503 are shown in the figure. According to the embodiment of the present invention, a turning angle R is configured to form between each sidewall 503 and the bottom surface 501 so as to form a four-edge curved structure of the protection cover.

Next, please refer to FIG. 6, which shows a schematic structural view of the modified curved protection cover in practical application in accordance with FIG. 5 of the present invention. From these two figures provided by the present invention, we can find that, the sidewall 503 of the four-edge curved protection cover comprises a bonding area 61 and a non-bonding area 63, in which the bonding area 61 is defined as an area of the curved protection cover 51 for performing its touch control functions. That is to say, as shown in FIG. 6, a preformed film 601 is able to be adhered to the bonding area 61 of the curved protection cover 51 via the optical glue 603. In such embodiment of the present invention, the optical glue 603 can be made of flowing liquid material, for example the Liquid Optically Clear Adhesive (LOCA).

On the contrary, the non-bonding area 63 is defined as an area of the curved protection cover 51 for not performing the touch control functions. According to a preferred embodiment of the present invention, a groove 65 is formed in the non-bonding area 63, such that the optical glue 603 can be filled into the groove 65 of the non-bonding area 63 when the preformed film 601 is adhered to the bonding area 61 of the curved protection cover 51, so as to avoid the above mentioned conventional overflow ng phenomenon of the optical glue 603.

In one embodiment of the present invention, the preformed film 601 can be selectively pre-formed from a flexible film. In addition, in order to meet the requirements that the proposed curved protection cover of the present invention can be applied to the fields of touch panel devices and its screen display technologies, a material of the curved protection cover can be employed as an optical transparent material. For instance, the curved protection cover 51 of the present invention can be made of optical transparent materials, such as crystal, glass, or resin (CR39, PC, PMMA, and so on).

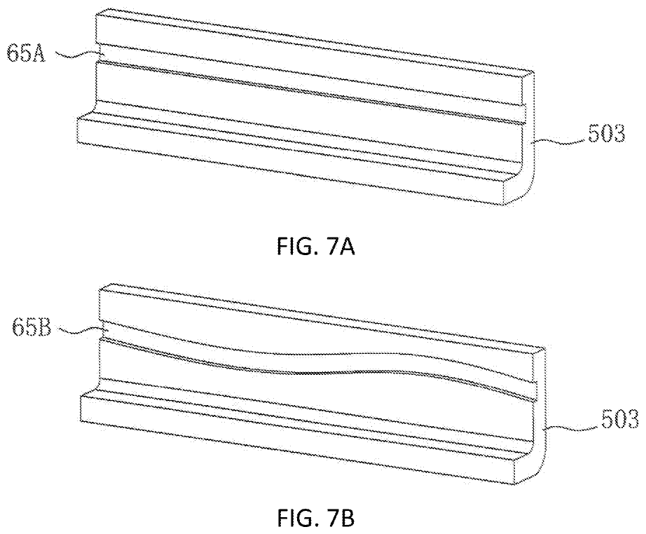

Furthermore, according to a preferred embodiment of the present invention, when each sidewall 503 of the curved protection cover 51 is provided with the above disclosed groove 65, all of these grooves 65 will be connecting with one another and form a circular type of groove. For example, the groove 65 can be fabricated by a wheel cutting or laser engraving method. In another aspect, please refer to FIG. 7A and FIG. 7B at the same time, which show various types of groove according to another two embodiments of the present invention. Among these, in one embodiment, then the proposed groove of the present invention can be designed as a linear type of groove 65A as shown in FIG. 7A. Alternatively, in another embodiment, the proposed groove of the present invention can also be designed as a curve type of groove 65B as shown in FIG. 7B. Or, according to yet other embodiments of the present invention, the groove type may also be other types having specific patterns. Those who are skilled in the art and have ordinary knowledge will be able to design their own groove patterns according to the practical actual requirements and process specifications, and the present invention is surely not limited to the above mentioned embodiments which have been disclosed herein.

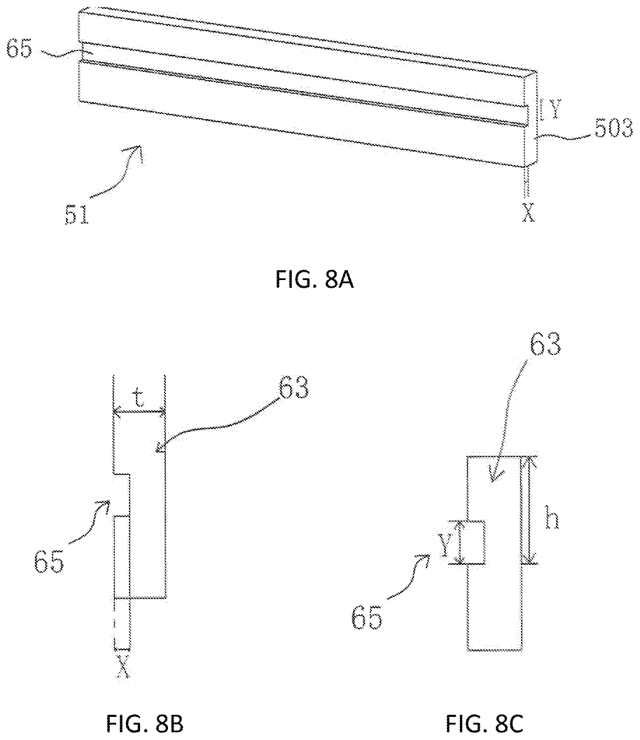

Moreover, according to the adhesion structure for the curved protection cover disclosed by the present invention, the size of the proposed groove to be designed can be adjusted according to shape of the four-edge curved structure of the protection cover. Hereinafter, when considering size of the groove to be designed, please refer to FIG. 8A, FIG. 8B, and FIG. 8C at the same time, which disclose various schematic views showing the dimensions of the groove to be designed according to the preferred embodiment of the present invention, in which the sidewall 503 of the curved protection cover 51 has a thickness t, and the depth X of the groove 65 is less than one-third of the thickness t of the sidewall, that is, X<(1/3)*(t) as shown in FIG. 8B. Meanwhile, the non-bonding area 63 in the sidewall 503 of the curved protection cover 51 has a non-adhesive height h, and the height Y of the groove 65 is less than half of the non-adhesive height h, which indicates Y<(1/2)*(h) as shown in FIG. 8C.

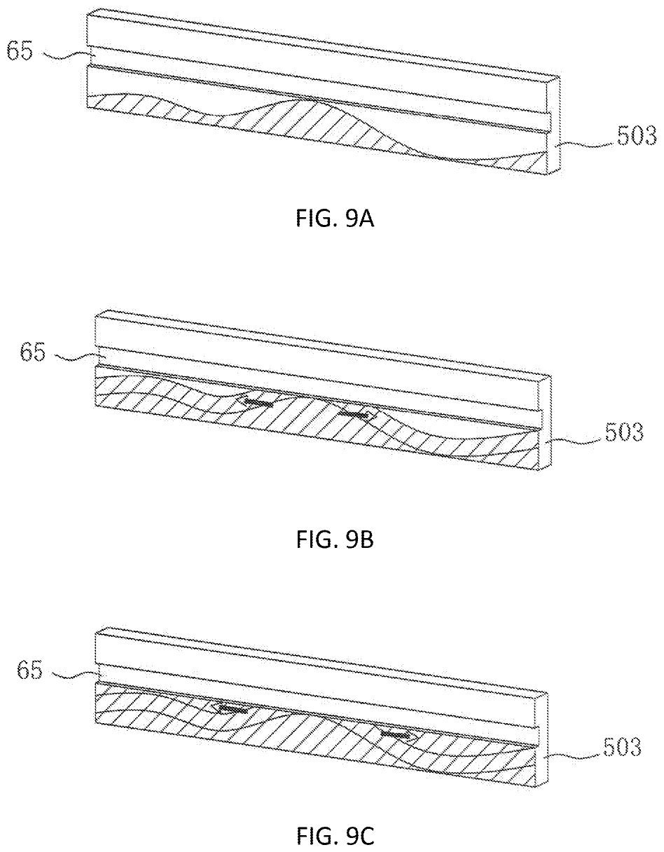

In the following section, we proceed to present diagrams of the simulation results by employing the proposed structure disclosed in the present invention so as to demonstrate the extraordinary effect of the present invention. Please refer to FIG. 9A, FIG. 9B, and FIG. 9C, which show diagrams of the simulation results when the curved protection cover provided with a circular type of groove of the present invention is applied to form its adhesion structure. As shown in these figures, it can be observed that when the circular type of groove is disposed in a vertical sidewall of the four-edge curved structure of the protection cover which performs no touch control functions, and a liquid glue is used to adhere the preformed film to the protection cover, the liquid glue flows into the groove 65 first, as indicated by the direction of the arrow in the figures, and then fills towards a horizontal direction, so the overflowing phenomenon can be prevented on the sidewall of the protection cover. The objective of the present invention is accomplished through the technical solution that the groove is formed on the sidewall of the protection cover. whereby the conventional overflowing phenomenon of the liquid glue can be controlled well and be eliminated effectively.

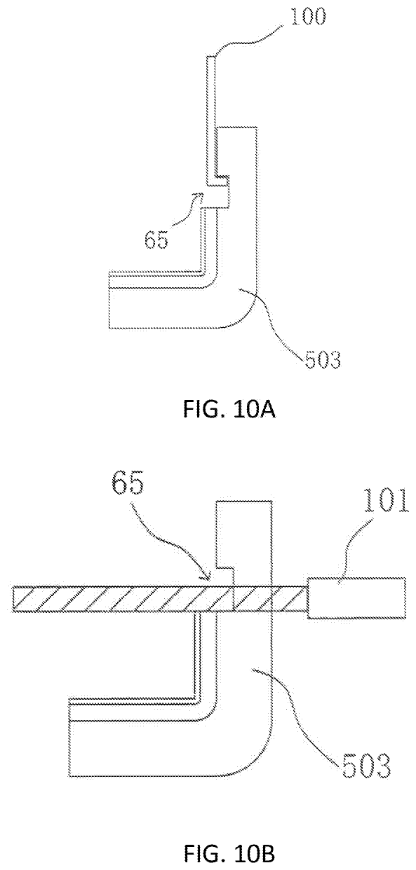

In a further perspective, in order to improve the efficiency of the present invention in practical application, FIG. 10A and FIG. 10B shows another two embodiments of the present invention when being brought into practical application. At first, please refer to FIG. 10A, in which a process fixture 100 can be further positioned in the groove 65 when the circular type of groove is used for adhesion process. As for another embodiment as shown in FIG. 10B, a light source 101 can be disposed adjacent to the sidewall 503 of the curved protection cover 51, so the groove 65 of the present invention can perform as a positioning standard for curing the light source at one side. As a result, in view of these two extensive embodiments, it is apparent that the proposed groove of the present invention can be used not only for the snap positioning of the process fixture, but also as a positioning standard for the side curing light source. Therefore, it is believed that by employing the proposed design, the present invention can be applied much more widely than before, and has a better industrial utilization when compared to the prior arts.

In view of the above, it is apparent that, compared to the prior arts, the adhesion structure for the curved protection cover disclosed in the present invention is able to be provided with corresponding groove patterns according to a variety of appearance requirements of a curved protection cover. By such, the conventional overflowing or wavy phenomenon of the optical liquid glue can be effectively eliminated. Meanwhile, the groove can be selectively fabricated by a wheel cutting or laser engraving method, which is further advantageous of both simple production process and rapid process time.

Apart from these, the adhesion structure for a curved protection cover of the present invention may also be further used for the snap positioning of its adjacent process fixture or alternatively as a positioning standard for a side curing light source. As a result, the present invention is believed to be able to be applied much more widely than before, and characterized by a better industrial utilization. As such, when compared to the prior arts, it is obvious that the present invention apparently shows much more effective performances than before and solves the issues occurring in the prior designs. While considering the complexity of the design process, it can also be optimized for the adhesion structure, which is obviously superior to the conventional technology. Therefore, to sum up, it is believed that the present invention is instinct, effective and highly competitive for recent technology and industries in the market nowadays, whereby having extraordinary availability and competitiveness for future industrial developments and being in condition for early allowance.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. An adhesion structure for a curved protection cover, comprising:
a preformed film;
an optical glue, made of flowing liquid material; and
a curved protection cover, comprising a bottom surface and four sidewalls connecting to said bottom surface, wherein a turning angle is configured to form between each of said sidewalls and said bottom surface, each of said sidewalls comprises a bonding area and a non-bonding area, said preformed film is adhered to said bonding area of said curved protection cover via said optical glue, and a groove is formed in said non-bonding area, and wherein said sidewall of said curved protection cover has a thickness, and a depth of said groove is less than one-third of said thickness of said curved protection cover, and wherein said non-bonding area in said sidewall of said curved protection cover has a non-adhesive height, and a height of said groove is less than half of said non-adhesive height such that said optical glue is filled into said groove of said non-bonding area when said preformed film is adhered to said bonding area of said curved protection cover, so as to prevent said optical glue from overflowing.

2. The adhesion structure for a curved protection cover according to claim 1, wherein said curved protection cover is made of optical transparent materials.

3. The adhesion structure for a curved protection cover according to claim 2, wherein said curved protection cover is made of crystal, glass, or resin.

4. The adhesion structure for a curved protection cover according to claim 1, wherein said grooves disposed on said sidewalls of said curved protection cover are connecting with one another and form a circular type of groove on said sidewalls.

5. The adhesion structure for a curved protection cover according to claim 1, wherein said groove is designed as a linear type of groove, a curve type of groove or other types having specific patterns.

6. The adhesion structure for a curved protection cover according to claim 1, wherein said groove is fabricated by a wheel cutting or laser engraving method.

7. (canceled)

8. (canceled)

9. The adhesion structure for a curved protection cover according to claim 1, wherein said preformed film is selectively pre-formed from a flexible film.

10. The adhesion structure for a curved protection cover according to claim 4, further comprising a process fixture, wherein said process fixture is able to be positioned in said circular type of groove.

11. The adhesion structure for a curved protection cover according to claim 4, further comprising using said circular type of groove as a positioning standard for a light source used for curing, such that said light source is disposed adjacent to one of said sidewalls of said curved protection cover and emits light for curing.
